(19) United States
(12) Patent Application Publication
(10) Pub. No.: US 2017/0356682 A1
(43) Pub. Date: Dec. 14, 2017

(54) AN EVAPORATOR FOR ENVIRONMENTAL TEST CHAMBER

(71) Applicant: SUZHOU SUSHI TESTING INSTRUMENT CO., LTD., Suzhou (CN)

(72) Inventors: Xiaoguang HUANG, Suzhou (CN); Ronghua ZHU, Suzhou (CN); Guolin ZHOU, Suzhou (CN)

(73) Assignee: SUZHOU SUSHI TESTING INSTRUMENT CO., LTD., Suzhou (CN)

(21) Appl. No.: 15/540,586

(22) PCT Filed: Mar. 23, 2015
(86) PCT No.: PCT/CN2015/074880

§ 371 Date: Jun. 29, 2017

(30) Foreign Application Priority Data
Dec. 29, 2014 (CN) 2014108361455

(51) Int. Cl. F25B 39/02; B01L 1/00; B01L 7/00; F28F 1/10; G01N 17/00

(52) U.S. Cl. CPC F25B 39/02; B01L 7/00; F28F 1/10; B01L 1/00; G01N 17/00

(57) ABSTRACT

An evaporator for environmental test chamber includes a plate-type fin and plurality of pipelines wherein: the pipelines are divided into three types: refrigerating pipelines, dehumidifying pipelines and defrosting pipelines; the refrigerating pipelines are arranged alternately one by one, more by more, and one by more with the dehumidifying pipelines in transverse direction of a plate surface of the plate-type fin; refrigerating pipelines receive a refrigerating refrigerant supplied from a refrigerating-system, the dehumidifying pipelines receive dehumidifying refrigerant supplied from a dehumidifying-system, and defrosting pipelines receive hot air discharged from the dehumidifying-system compressor exhaust hole. The evaporator is simultaneously used for refrigerating and dehumidifying, and refrigerating and dehumidifying share the evaporator's whole evaporation area, and at least one evaporator pipeline is remained to serve as the defrosting pipelines, guiding the hot air output from the compressor of the dehumidifying-system to the evaporator to heat the evaporator surface to achieve the defrosting effect.

### TECHNICAL FIELD

The present invention is related to the environmental test device field, especially related to an evaporator for environmental test chamber.

### BACKGROUND OF INVENTION

An environmental test chamber applies the scientific and technological means to simulate the natural environment and its destruction to the modern industrial products and the typical tests of environmental test chamber are: high temperature test, low temperature test, high and low temperature alternating temperature humidity test, etc. To achieve the above-mentioned tests, the environmental test chamber mainly controls the temperature and humidity, so the environmental test chamber is designed with a refrigerating system, a dehumidifying system and a humidifier, etc.

In the prior art, the evaporator in the refrigerating system of the environmental test chamber is composed of a plurality of plate-type fins arranged in a distance and the heat exchange tubes on the plate-type fins and the existing evaporator could only dehumidify with a dry air device at low temperatures. For the dehumidification, the energy consumption of the dry air device is high and the dehumidification effect is limited.

Additionally, in the low temperature and humid conditions, the water vapor in the air encounters the plate-type fins, the evaporator will have frosting, which greatly reduces the working capacity. The way of defrosting is a necessary problem to be considered for the existing evaporator and the existing evaporator mostly applies the electrical heating component for the defrosting, which increases the surface temperature of the evaporator fins for defrosting, but consumes a lot of energy.

### DISCLOSURE OF THE INVENTION

The purpose of present invention is to supply an evaporator for environmental test chamber to make the refrigerating and dehumidifying share the whole evaporation area with the defrosting function with low energy consumption.

To achieve the above purpose, the technical solution applied in this invention is: an evaporator for environmental test chamber comprises a plurality of plate-type fins arranged in parallel and a plurality of pipelines extending through the plate-type fins, and each pipeline is a coil-like pipe formed by a straight pipe portion extending through the plate-type fin and a bent pipe portion connected to both ends of the straight pipe portion; on the plate surface of the plate-type fin, the respective pipelines are arranged in the longitudinal direction and are arranged apart in the transverse direction; and the pipelines are divided into three types: refrigerating pipelines, dehumidifying pipelines and defrosting pipelines; the refrigerating pipelines are multiple, the dehumidifying pipelines are multiple, and the defrosting pipelines are at least one; the refrigerating pipelines are arranged alternately one by one, one by more or more by more with the dehumidifying pipelines in a transverse direction of a plate surface of the plate-type fin; the refrigerating pipelines receive a refrigerating refrigerant supplied from a refrigerating system, the dehumidifying pipelines receive a dehumidifying refrigerant supplied from a dehumidifying system, and the defrosting pipelines receive the hot air discharged from an exhaust hole of a compressor of the dehumidifying system.

In above described technical solution, the defrosting pipelines are multiple, and the defrosting pipelines are arranged alternately with the refrigerating pipelines and dehumidifying pipelines.

The design principle and effect of present invention is as follows: The pipelines on the evaporator in the existing refrigerating system are all heat exchange pipes (i.e. refrigerating pipelines), but the present invention designs some of the pipelines of evaporator to be refrigerating pipelines and the others to dehumidifying pipelines and the refrigerating pipelines are arranged alternately one by one, one by more or more by more with the dehumidifying pipelines, i.e. the refrigerating and dehumidifying share the evaporator and share the whole evaporation area of the evaporator. And at least one of the evaporator pipelines is used as the defrosting pipeline and the defrosting pipelines receive the hot air discharged from an exhaust hole of a compressor of the dehumidifying system to guide the heat discharged from the compressor of the dehumidifying system to the evaporator surface for heating up and defrosting to reduce the frosting in the low temperature and high humidity condition.

### BRIEF DESCRIPTION OF THE DRAWINGS

FIG. 1 is the front view of embodiment of present invention;

FIG. 2 is the right view of FIG. 1;

FIG. 3 is the view of pipelines of embodiment of present invention.

In the above figures: 1. plate-type fin; 2. Pipelines; 21, straight pipe portion; 22, bent pipe portion; A. refrigerating pipelines; B. dehumidifying pipelines; C. defrosting pipelines

### SPECIFIC EMBODIMENT

With reference to the accompanying drawings and embodiment, the present invention will be described in detail.

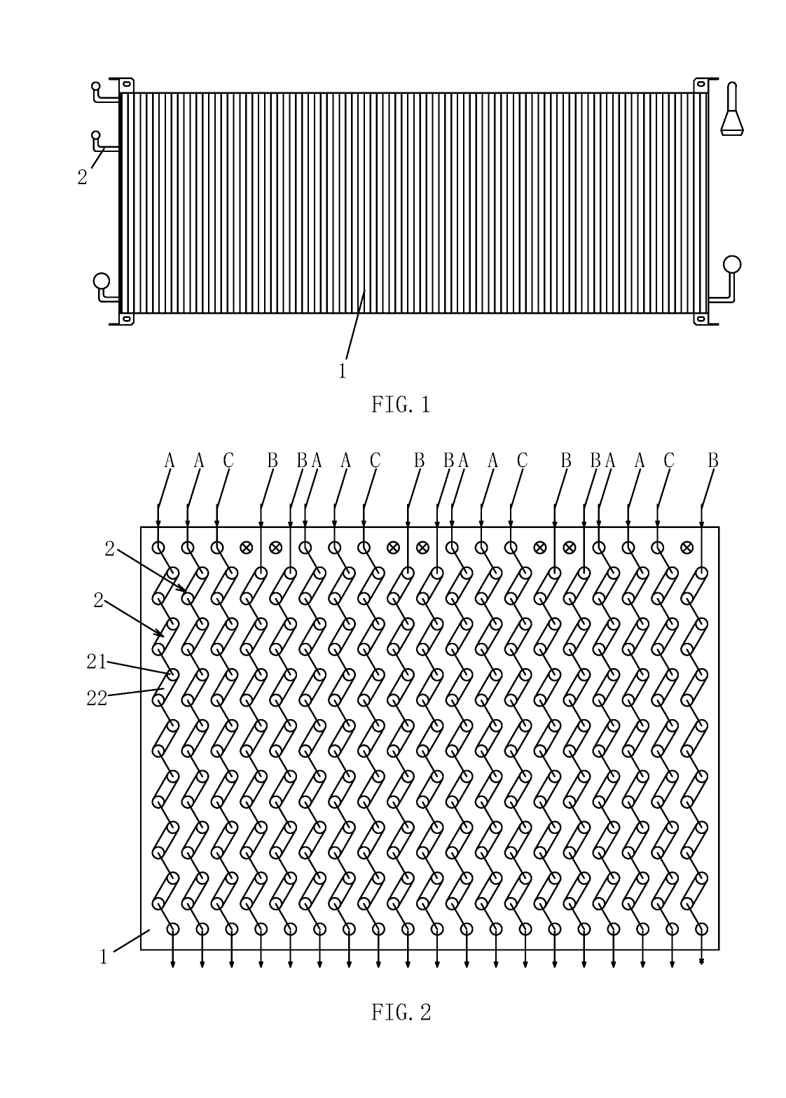

Embodiment: refer to FIG. 1-3:
An evaporator for environmental test chamber as shown in FIGS. 1 and 2 comprises a plurality of plate-type fins 1 arranged in parallel and a plurality of pipelines 2 extending through the plate-type fins.

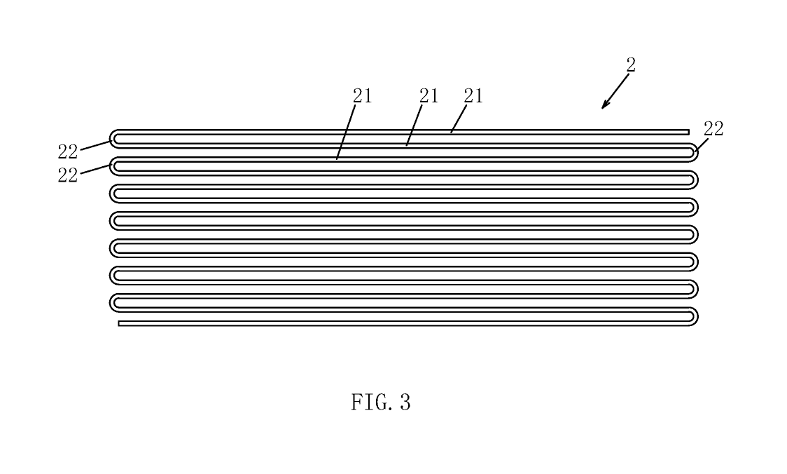

As shown in FIG. 3, each pipeline 2 is a coil-like pipe formed by a straight pipe portion 21 extending through the plate-type fin 1 and a bent pipe portion 22 connected to both ends of the straight pipe portion 21.

As shown in FIG. 2, on the plate surface of the plate-type fin 1, the respective pipelines 2 are arranged in the longitudinal direction and are arranged apart in the transverse direction, and the longitudinal direction means the up-down direction in FIG. 2 and the transverse direction means the left-right direction. The top end of each pipeline is used as the inlet and the bottom end is used as the outlet.

As shown in FIG. 2, the pipelines 2 are divided into three types: refrigerating pipelines A, dehumidifying pipelines B and defrosting pipelines C. The refrigerating pipelines A are multiple, the dehumidifying pipelines B are multiple, and the defrosting pipelines C are at least one and its illustration in the Figure is multiple. Usually the quantity of defrosting pipelines C is less than refrigerating pipelines A and dehumidifying pipelines B.

As shown in FIG. 2, the refrigerating pipelines A, dehumidifying pipelines B and defrosting pipelines C are arranged alternately one by one, one by more or more by more in a transverse direction of a plate surface of the plate-type fin and the specific arrangement is not limited and its preferable to apply the repeated arrangement of basic repeated unit, which makes it more uniform.

The specific arrangement of refrigerating pipelines A, dehumidifying pipelines B and defrosting pipelines C in this embodiment is: as shown in FIG. 2, the arrangement of two refrigerating pipelines A, one defrosting pipeline C and two dehumidifying pipelines B from left to right is the basic repeated unit and the overall arrangement is based on such basic repeated unit. That is, as shown in FIG. 2, the arrangement from left to right is two refrigerating pipelines A, one defrosting pipeline C and two dehumidifying pipelines B, then two refrigerating pipelines A, one defrosting pipeline C and two dehumidifying pipelines B . . . .

The refrigerating pipelines A receive a refrigerating refrigerant supplied from a refrigerating system, the dehumidifying pipelines B receive a dehumidifying refrigerant supplied from a dehumidifying system, and the defrosting pipelines C receive the hot air discharged from an exhaust hole of a compressor of the dehumidifying system.

The refrigerating system means the refrigerating system consisting of the evaporator of this embodiment with the compressor, condenser and pipelines; the dehumidifying system means the compressor type dehumidifying system consisting of the evaporator of this embodiment with the compressor and pipelines.

In this embodiment, the evaporator is simultaneously used for refrigerating and dehumidifying, and the refrigerating and dehumidifying share the whole evaporation area of the evaporator. And at least one of the evaporator pipelines is used as the defrosting pipeline and the defrosting pipelines receive the hot air discharged from an exhaust hole of a compressor of the dehumidifying system to guide the heat discharged from the compressor of the dehumidifying system to the evaporator surface for heating up and defrosting to reduce the frosting in the low temperature and high humidity condition.

It should be noted that the above described embodiments are only for illustration of technical concept and characteristics of present invention with purpose of making those skilled in the art understand the present invention, and thus these embodiments shall not limit the protection range of present invention. The equivalent changes or modifications according to spiritual essence of present invention shall fall in the protection scope of present invention.

1. An evaporator for environmental test chamber comprises a plurality of plate-type fins arranged in parallel and a plurality of pipelines extending through the plate-type fins, and each pipeline is a coil-like pipe formed by a straight pipe portion extending through the plate-type fin and bent pipe portions connected to both ends of the straight pipe portion; on the plate surface of the plate-type fin, the respective pipelines are arranged in the longitudinal direction and are arranged apart in the transverse direction; wherein: the pipelines are divided into three types: refrigerating pipelines, dehumidifying pipelines and defrosting pipelines; the refrigerating pipelines are multiple, the dehumidifying pipelines are multiple, and the defrosting pipelines are at least one; the refrigerating pipelines are arranged alternately one by one or one by more or more by more with the dehumidifying pipelines in a transverse direction of a plate surface of the plate-type fin; the refrigerating pipelines receive a refrigerating refrigerant supplied from a refrigerating system, the dehumidifying pipelines receive a dehumidifying refrigerant supplied from a dehumidifying system, and the defrosting pipelines receive hot air discharged from an exhaust hole of a compressor of the dehumidifying system.

2. The said evaporator for environmental test chamber of claim 1 wherein: the defrosting pipelines are multiple and the defrosting pipelines are arranged alternately with the refrigerating pipelines and dehumidifying pipelines.
